(19) United States
(12) Patent Application Publication
(10) Pub. No.: US 2026/0127804 A1
(43) Pub. Date: May 7, 2026

(54) AUTOMATED CREATION OF ANIMATION CONTROLLERS

(71) Applicant: Roblox Corporation, San Mareo, CA (US)

(72) Inventors: Jinseok BAE, Seoul (KR); Mubbasir Turab KAPADIA, San Mateo, CA (US); Young Yoon LEE, San Mateo, CA (US); Joseph LIU, San Mateo, CA (US)

(73) Assignee: Roblox Corporation, San Mateo, CA (US)

(21) Appl. No.: 19/380,194

(22) Filed: Nov. 5, 2025

Related U.S. Application Data
(60) Provisional application No. 63/716,641, filed on Nov. 5, 2024.

(51) Int. Cl. G06T 13/40; G06V 10/46; G06V 10/77; G06V 10/82

(52) U.S. Cl. CPC G06T 13/40; G06V 10/462; G06V 10/7715; G06V 10/82

(57) ABSTRACT

Some implementations relate to methods, systems, and computer readable media for automated creation of animation controllers. According to one aspect, a computer-implemented method includes obtaining one or more motion descriptions comprising natural-language prompts describing motions of an avatar and encoding the descriptions into a motion embedding vector. A noisy motion representation comprising sparse keyframes representing skeletal poses is generated and iteratively refined using a pre-trained diffusion model over a plurality of timesteps. At each timestep, a denoised motion representation is estimated, a keyframe mask is dynamically updated, and an updated motion representation is obtained. A final motion representation corresponding to a last timestep is used to generate one or more motion clips defining avatar movements of the avatar, which are assembled into an animation controller represented by a motion graph specifying transitions between animation states.

### CROSS-REFERENCE TO RELATED APPLICATIONS

This application claims priority to U.S. Provisional Patent Application No. 63/716,641, filed Nov. 5, 2024, and titled “AUTOMATED CREATION OF ANIMATION CONTROLLERS,” the entire contents of which are incorporated by reference herein.

### TECHNICAL FIELD

Various implementations described herein relate generally to computer-generated animation, and more particularly but not exclusively, relates to methods, systems, and computer-readable media for automating the creation of animation controllers.

### BACKGROUND

The development of computer-generated animation systems, which can be used in interactive virtual experiences such as gaming experiences, has introduced numerous challenges in the creation and management of avatar animations. Responsive and temporally consistent animations are important for maintaining immersion in real-time or near-real-time applications where user commands are reflected promptly and accurately in avatar movements. Traditionally, creating an animation controller, a framework that coordinates and blends multiple animation clips based on user input or automated behavior, includes extensive manual configuration. The creation includes generating, editing, and aligning large sets of animation clips to achieve realistic transitions between motion states, such as walking, running, or jumping.

Current techniques for building animation controllers rely on sequential manual steps, including, e.g., collecting motion data, editing animation clips to satisfy physical or logical constraints (such as loop continuity or ground contact alignment), and synchronizing transitions between clips. The procedures account for real-time blending and runtime variability in user input or predefined system behavior. As the number of animation states increases, the associated control logic and synchronization complexity grow exponentially, making the construction of animation controllers resource-intensive and prone to configuration errors.

Generative artificial intelligence (AI) models, including those developed for motion synthesis, have been applied to automate portions of animation creation. The generative AI models lack sufficient control and consistency for production use. Outputs may include visual defects such as, e.g., unstable joint motion, foot sliding, or discontinuities across frames. Training datasets can be limited in scope and diversity, restricting model generalization to the broad range of motions in interactive environments.

Some generative motion models depend on dense temporal sampling of pose data, which can obscure key poses that define a motion sequence. The dense representation can reduce temporal interpretability and make it difficult to generate transitions that align properly across multiple animation clips.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Various implementations described herein relate to methods, systems, and computer-readable media to automate the creation of animation controllers.

According to one aspect, a computer-implemented method includes obtaining one or more motion descriptions including one or more natural-language prompts describing avatar motions. The computer-implemented method further includes encoding the one or more motion descriptions into a motion embedding vector. The computer-implemented method further includes generating a noisy motion representation based on the motion embedding vector, where the noisy motion representation includes a sparse set of keyframes representing skeletal poses of an avatar over time. The computer-implemented method further includes iteratively refining the noisy motion representation using a pre-trained diffusion model over a number of timesteps, where the iterative refinement includes, at each timestep: estimating, by the pre-trained diffusion model configured to represent motion sequences using sparse keyframes, a denoised motion representation based on the noisy motion representation and the current timestep; dynamically updating a keyframe mask that identifies salient keyframes of the denoised motion representation based on variation in joint position or motion velocity over time; obtaining an updated motion representation as the noisy motion representation based on the denoised motion representation and a motion representation obtained at a previous timestep; and updating the timestep. The computer-implemented method further includes obtaining a final motion representation corresponding to a last timestep of the iterative refinement. The computer-implemented method further includes generating, based on the final motion representation, one or more motion clips defining avatar movements of the avatar. The computer-implemented method further includes assembling the one or more motion clips into an animation controller represented by a motion graph specifying one or more transitions between animation states.

In some implementations, dynamically updating the keyframe mask includes weighting keyframes based on magnitude of joint displacement or temporal motion energy.

In some implementations, the pre-trained diffusion model includes a neural network trained to jointly process sparse keyframes and corresponding temporal indices to maintain timing consistency across motion sequences.

In some implementations, the noisy motion representation and the denoised motion representation each include skeletal pose data expressed as three-dimensional (3D) joint coordinates for a number of joints of the avatar.

In some implementations, the computer-implemented method further includes generating, using at least one secondary pre-trained diffusion model, one or more additional motion clips that are temporally aligned with the one or more motion clips generated by the pre-trained diffusion model to form a combined set of motion clips.

In some implementations, the computer-implemented method further includes generating, based on identified transition points between the combined set of motion clips, one or more intermediate motion frames using one or more interpolation techniques.

In some implementations, the computer-implemented method further includes synchronizing the combined set of motion clips using the one or more intermediate motion frames to obtain synchronized motion clips, and assembling the synchronized motion clips into the animation controller represented by the motion graph specifying one or more transitions between animation states.

In some implementations, the pre-trained diffusion model is regularized using a Lipschitz-constrained loss to maintain bounded continuity of interpolated joint positions across two or more timesteps of the number of timesteps.

In some implementations, the computer-implemented method further includes augmenting a motion dataset used to train the pre-trained diffusion model by automatically assigning labels to unlabeled motion sequences with natural-language descriptions, and refining the labels using a language model.

In some implementations, augmenting the motion dataset further includes generating a number of varied motion sequences by procedurally modifying the unlabeled motion sequences to create additional sequences having variations in motion parameters.

According to another aspect, a computing device includes one or more processors, and memory coupled to the one or more processors with instructions stored thereon that, when executed by the one or more processors, cause the one or more processors to perform operations including obtaining one or more motion descriptions including one or more natural-language prompts describing avatar motions. The instructions cause the one or more processors to perform a further operation including encoding the one or more motion descriptions into a motion embedding vector. The instructions cause the one or more processors to perform a further operation including generating a noisy motion representation based on the motion embedding vector, where the noisy motion representation includes a sparse set of keyframes representing skeletal poses of an avatar over time. The instructions cause the one or more processors to perform a further operation including iteratively refining the noisy motion representation using a pre-trained diffusion model over a number of timesteps, where the iterative refinement includes, at each timestep: estimating, by the pre-trained diffusion model configured to represent motion sequences using sparse keyframes, a denoised motion representation based on the noisy motion representation and the current timestep; dynamically updating a keyframe mask that identifies salient keyframes of the denoised motion representation based on variation in joint position or motion velocity over time; obtaining an updated motion representation as the noisy motion representation based on the denoised motion representation and a motion representation obtained at a previous timestep; and updating the timestep. The instructions cause the one or more processors to perform a further operation including obtaining a final motion representation corresponding to a last timestep of the iterative refinement. The instructions cause the one or more processors to perform a further operation including generating, based on the final motion representation, one or more motion clips defining avatar movements of the avatar. The instructions cause the one or more processors to perform a further operation including assembling the one or more motion clips into an animation controller represented by a motion graph specifying one or more transitions between animation states.

In some implementations, dynamically updating the keyframe mask includes weighting keyframes based on magnitude of joint displacement or temporal motion energy.

In some implementations, the pre-trained diffusion model includes a neural network trained to jointly process sparse keyframes and corresponding temporal indices to maintain timing consistency across motion sequences.

In some implementations, the noisy motion representation and the denoised motion representation each include skeletal pose data expressed as three-dimensional (3D) joint coordinates for a number of joints of the avatar.

In some implementations, the instructions cause the one or more processors to perform a further operation including generating, using at least one secondary pre-trained diffusion model, one or more additional motion clips that are temporally aligned with the one or more motion clips generated by the pre-trained diffusion model to form a combined set of motion clips.

According to another aspect, a non-transitory computer-readable medium includes instructions stored thereon that, when executed by a processor, cause the processor to perform operations including obtaining one or more motion descriptions including one or more natural-language prompts describing avatar motions. The instructions cause the one or more processors to perform a further operation including encoding the one or more motion descriptions into a motion embedding vector. The instructions cause the one or more processors to perform a further operation including generating a noisy motion representation based on the motion embedding vector, where the noisy motion representation includes a sparse set of keyframes representing skeletal poses of an avatar over time. The instructions cause the one or more processors to perform a further operation including iteratively refining the noisy motion representation using a pre-trained diffusion model over a number of timesteps, where the iterative refinement includes, at each timestep: estimating, by the pre-trained diffusion model configured to represent motion sequences using sparse keyframes, a denoised motion representation based on the noisy motion representation and the current timestep; dynamically updating a keyframe mask that identifies salient keyframes of the denoised motion representation based on variation in joint position or motion velocity over time; obtaining an updated motion representation as the noisy motion representation based on the denoised motion representation and a motion representation obtained at a previous timestep; and updating the timestep. The instructions cause the one or more processors to perform a further operation including obtaining a final motion representation corresponding to a last timestep of the iterative refinement. The instructions cause the one or more processors to perform a further operation including generating, based on the final motion representation, one or more motion clips defining avatar movements of the avatar. The instructions cause the one or more processors to perform a further operation including assembling the one or more motion clips into an animation controller represented by a motion graph specifying one or more transitions between animation states.

In some implementations, dynamically updating the keyframe mask includes weighting keyframes based on magnitude of joint displacement or temporal motion energy.

In some implementations, the pre-trained diffusion model includes a neural network trained to jointly process sparse keyframes and corresponding temporal indices to maintain timing consistency across motion sequences.

In some implementations, the noisy motion representation and the denoised motion representation each include skeletal pose data expressed as three-dimensional (3D) joint coordinates for a number of joints of the avatar.

In some implementations, the instructions cause the one or more processors to perform a further operation including generating, using at least one secondary pre-trained diffusion model, one or more additional motion clips that are temporally aligned with the one or more motion clips generated by the pre-trained diffusion model to form a combined set of motion clips.

In some implementations, a computer-implemented method includes obtaining one or more motion descriptions that describe avatar motions. The method further includes encoding the one or more motion descriptions into a motion embedding vector. The method further includes generating a noisy motion representation based on the motion embedding vector. The method further includes iteratively refining the noisy motion representation using a pre-trained diffusion model over a plurality of timesteps to obtain a final motion representation at the final timestep that is denoised from the noisy motion representation. The method further includes generating, based on the final motion representation, one or more motion clips defining avatar movements of the avatar and assembling the one or more motion clips into an animation controller.

In some implementations, a motion description may include one or more natural-language prompts. In some implementations, the noisy motion representation includes a sparse set of keyframes representing skeletal poses of an avatar as the avatar undergoes motion. In some implementations, the iterative refinement includes, at each timestep: estimating, a denoised motion representation based on the noisy motion representation and the current timestep; dynamically updating a keyframe mask that identifies salient keyframes of the denoised motion representation; obtaining an updated motion representation as the noisy motion representation based on the denoised motion representation and a motion representation obtained at a previous timestep; and updating the timestep. In some implementations, the keyframe mask identifies salient keyframes of the denoised motion representation based on variation in joint position or motion velocity, or a combination thereof. In some implementations, the animation controller is represented by a motion graph that specifies one or more transitions between animation states.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of the disclosure.

### BRIEF DESCRIPTION OF THE DRAWINGS

FIG. 1 is a diagram of an example system architecture to automate the creation of animation controllers, in accordance with some implementations.

FIG. 2A is a flow diagram illustrating an example method 200 to automate creation of an animation controller, in accordance with some implementations.

FIG. 2B is a flow diagram illustrating an example method 220 to provide iterative refinement of a noisy motion representation using a pre-trained diffusion model, in accordance with some implementations.

FIG. 3 is a flow diagram illustrating an additional example method to automate creation of an animation controller, in accordance with some implementations.

FIG. 4 is a flow diagram illustrating an example of a motion keyframes diffusion model, in accordance with some implementations.

FIG. 5 is a flow diagram illustrating an example of using a Lipschitz multilayer perceptron (MLP) to improve the smoothness of manifold embedding in pose representations for frames, in accordance with some implementations.

FIG. 6 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation”, “an implementation”, “an example implementation”, “some implementations”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various implementations described herein enable automated generation of animation controllers by applying diffusion-based generative techniques to sparse keyframe motion representations. In some implementations, a method includes obtaining motion descriptions, such as natural-language prompts, converting the motion descriptions into motion embeddings, and iteratively refining the embeddings by a pre-trained diffusion model to produce denoised motion sequences. Each sequence is represented using a sparse set of keyframes dynamically updated during the refinement based on changes in joint position or motion velocity. The resulting motion representations are used to generate motion clips and to automatically construct animation controllers represented as motion graphs specifying transitions between animation states. Some implementations may further incorporate one or more auxiliary (or secondary) diffusion models for temporal alignment across motion clips, interpolation techniques to generate intermediate frames, and dataset augmentation procedures to improve motion diversity and label consistency.

Technical advantages of various implementations described herein include improved efficiency in generating animation controllers by employing diffusion-based generative models configured to iteratively refine sparse keyframe motion representations. Unlike dense frame synthesis techniques that require extensive data and manual curation, implementations described herein generate motion sequences directly from text or structured motion descriptions using compact pose representations, with significantly lower computational and data requirements for producing controllable animations.

Another technical advantage of some implementations is the use of dynamic keyframe masking to identify and update salient keyframes during the diffusion. The adaptive mechanism enables the refinement to focus on temporally and spatially relevant motion states, which improves continuity and realism of generated motion without relying on predefined segmentation or handcrafted constraints. The result is a more stable and interpretable denoising suitable for complex, multi-joint motion sequences.

A further technical advantage of certain implementations is the ability to automatically align and synchronize multiple generated motion clips to form functional animation controllers, e.g., that can be used to animate a three-dimensional (3D) avatar in a virtual 3D space such as a virtual experience. By integrating auxiliary (secondary) diffusion models and interpolation techniques for temporal alignment, various implementations described herein provide consistent transitions between motion states, enabling automatic construction of motion graphs that define transitions and blending logic without manual tuning.

Another technical advantage of some implementations described herein is enhanced scalability and dataset efficiency through procedural dataset augmentation and automatic natural-language labeling of unlabeled motion sequences. The capabilities expand the diversity and labeling accuracy of training datasets, improving model generalization to new motions and reducing the need for expensive manual annotation or motion capture data collection.

Yet another technical advantage of one or more described implementations is the ability to produce animation controllers that can be integrated directly into real-time or interactive virtual environments. Because the implementations described herein output motion clips and controller structures compatible with runtime compositors, developers can incorporate the generated content into game engines or other avatar animation systems with minimal post-processing, improving responsiveness and reducing development cycles for interactive animation systems.

Various implementations described herein are directed towards, inter alia, techniques to automate the creation of animation controllers for virtual environments by employing diffusion-based generative models and sparse keyframe motion representations. In some implementations, a method includes obtaining motion descriptions from user input, generating noisy motion representations, and iteratively refining the representations over a plurality of timesteps (where refinement is performed sequentially over consecutive timesteps) using a pre-trained diffusion model to produce denoised motion sequences. Each motion sequence is represented by a sparse set of keyframes dynamically updated during the refinement based on variation in joint position or motion velocity. The resulting motion data can be automatically organized into motion clips and assembled into animation controllers represented as motion graphs specifying transitions between animation states. Various implementations support automatic dataset augmentation, natural-language labeling of motion data, and generation of intermediate frames for temporal alignment across multiple motion clips, improving the scalability and consistency of animation controller creation in interactive virtual environments.

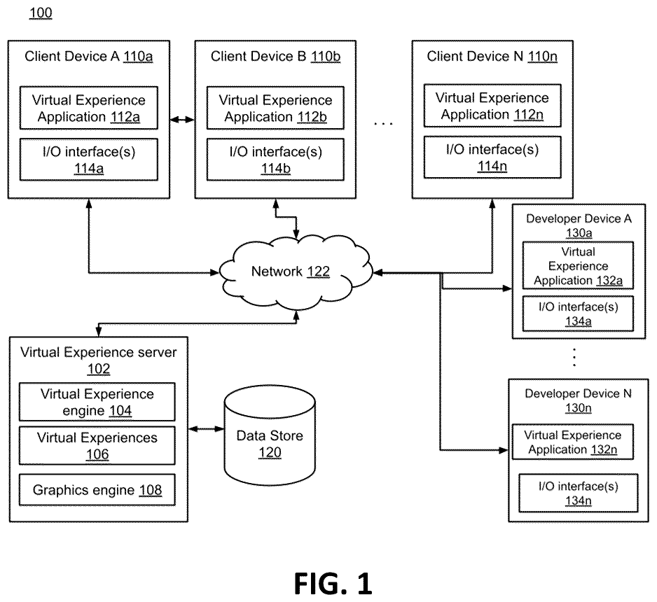

FIG. 1 is a diagram of an example system architecture to automate the creation of animation controllers, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

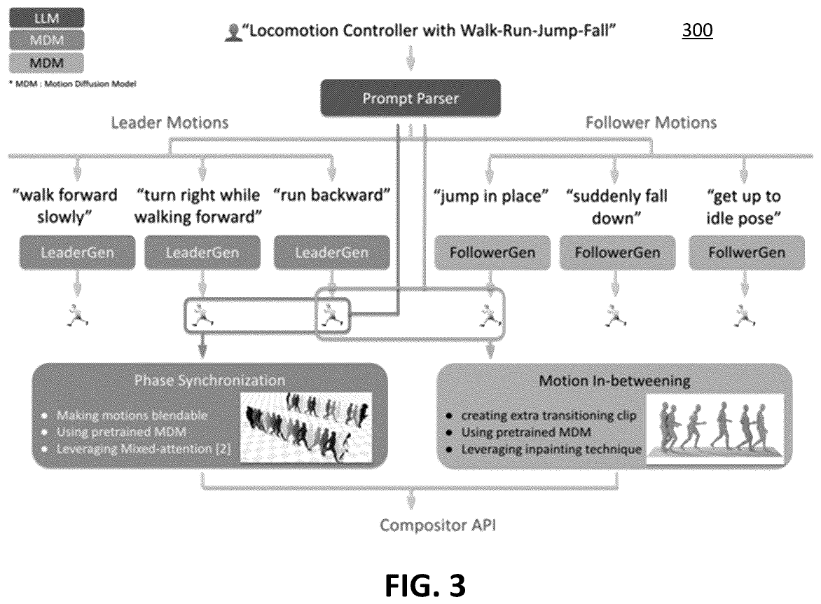

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 3. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. Other implementations of the disclosure may include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time or near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character which may be an avatar in the virtual environment, e.g., associated with a playing user, or as a non-playing character (NPC) in the virtual environment, may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. Virtual experience engine 104 implements the techniques described herein. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For example, the online virtual experience server 102 may perform one or more logical operations (e.g., using virtual experience engine 104) on the control instructions to generate experience instruction(s) for the client devices 110. In other examples, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to enable an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to enable the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

In some implementations, the animation controllers generated using the described techniques can be applied directly to control avatar motions within a 3D virtual environment. The avatar may be defined by a rig including a set of predefined skeletal joints and associated constraints corresponding to a specific avatar configuration, such as those used in a virtual experience platform. When the animation controller is deployed, it automatically governs the motion of the avatar according to the generated motion clips and associated motion graph transitions. The motion graph defines transitions between animation states such as, e.g., walking, running, jumping, or falling, which are selected based on the context of user input or scripted conditions within the virtual environment.

For example, a user may provide a text prompt such as “the avatar runs forward and then leaps into the air while spinning.” The virtual experience engine 104 processes the prompt to generate motion embeddings, synthesize corresponding motion clips, and assemble them into an animation controller. When the avatar is rendered in the virtual environment, the animation controller automatically applies the synthesized motions to the skeletal joints of the avatar. The resulting sequence allows the avatar to exhibit natural transitions between movement states, such as accelerating from a walk to a run, leaping, and rotating mid-air, without requiring the user to define individual joint trajectories or timing parameters. In this manner, the described techniques reduce the manual effort involved in authoring and synchronizing motion data, enabling consistent and context-aware animation behavior across different avatars and experiences.

In some implementations, the virtual experience server 102 includes a virtual experience engine 104 that executes logic for generating motion clips and animation controllers based on natural-language prompts or other motion descriptions. The engine 104 may perform one or more operations for the implementations described herein, such as obtaining motion embeddings from textual input, generating noisy motion representations composed of sparse keyframes, and iteratively refining the representations using one or more pre-trained diffusion models to produce denoised motion sequences. The generated motion clips may be automatically synchronized and assembled into animation controllers represented as motion graphs defining transitions between animation states. By performing motion generation and synchronization operations server-side, motion controllers can be produced dynamically and delivered to client devices 110 with reduced computational overhead on the client.

Client devices 110 execute a virtual experience application 112 that receives and renders motion clips or animation controllers generated by the server. In some implementations, the application 112 may transmit natural-language prompts, configuration parameters, or avatar-specific attributes to the server to guide generation of motion sequences. The application 112 may cache motion clips and controller data for reuse across multiple avatars or interactive sessions, reducing latency in playback. In certain configurations, the client device may apply lightweight post-processing operations such as skeletal retargeting, inverse kinematics adjustments, or frame-rate adaptation to align the received motion data with device-specific constraints or avatar proportions while maintaining synchronization defined by the animation controller.

In some implementations, the techniques described herein for generating and assembling motion clips, performing iterative refinement using one or more pre-trained diffusion models, and/or constructing animation controllers may be executed by the virtual experience engine 104, the graphics engine 108, or the virtual experience application 112, or any combination thereof. Although FIG. 1 depicts the virtual experience engine 104 on the server side, the same or similar operations can be implemented at least in part by the virtual experience application 112 executing on a client device. For example, the client-side application may locally execute the pre-trained diffusion model to refine noisy motion representations or to generate animation controllers for latency-sensitive scenarios, such as avatar animation during live user interaction. In other implementations, the graphics engine 108 may perform rendering and synchronization of motion clips generated either on the client or the server.

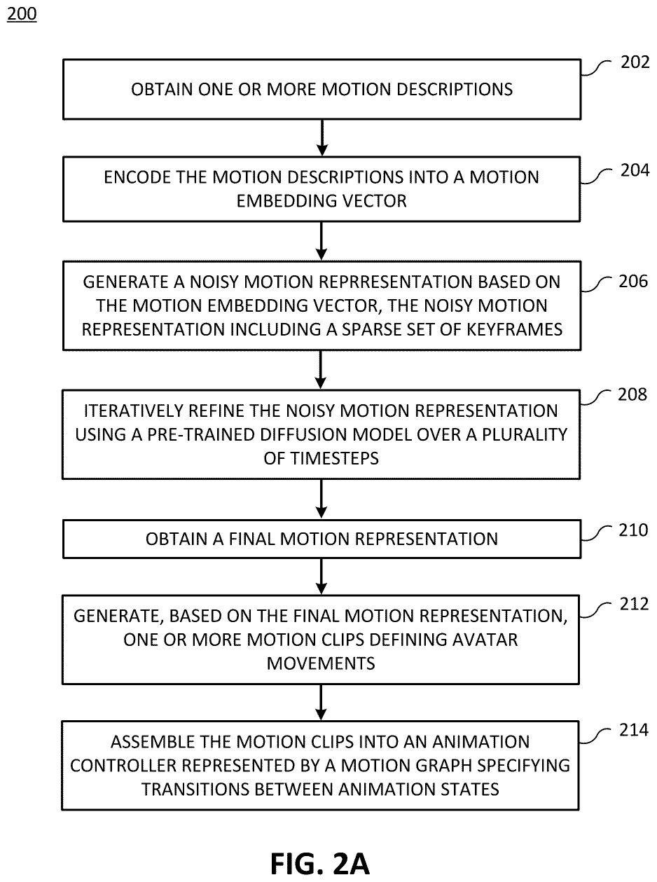

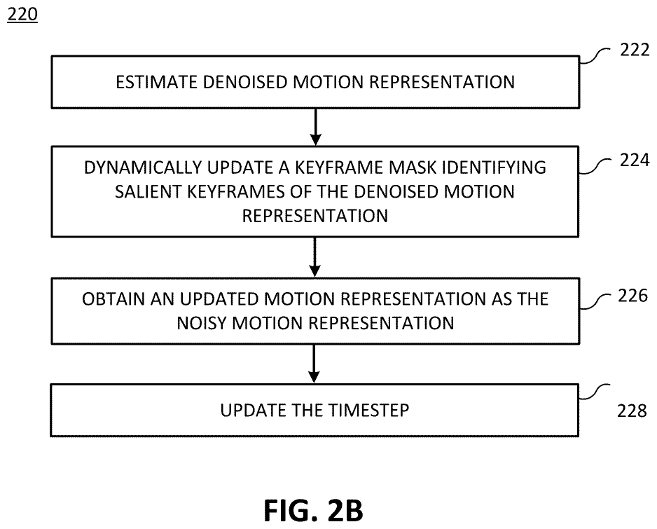

FIG. 2A is a flow diagram illustrating an example method 200 to automate creation of an animation controller, in accordance with some implementations. In various implementations, the blocks shown in FIG. 2A and described below may be performed by any of the computing devices illustrated in FIG. 1, e.g., one or more of client devices 110 and/or online virtual experience server 102. For example, two or more client devices 110 may perform method 200, or at least one client device 110 and online virtual experience server 102 may perform method 200. In some implementations, certain blocks of method 200 may be performed by a client device 110 and other blocks of method 200 may be performed by an online virtual experience server 102.

Some implementations described herein may make use of user-provided or user-associated data, such as avatar motion sequences, interaction data from a virtual environment, or user-generated descriptions of motion in text, audio, or video form. In such cases, data is collected and processed with user consent and in compliance with applicable data protection regulations. Any identifiable user information is excluded or anonymized before being used to train, fine-tune, or evaluate the machine-learned diffusion models. When motion or interaction data is incorporated into training or evaluation pipelines, de-identified motion features or aggregated statistics are retained. Data storage is limited to the duration necessary for its intended purpose, after which it is deleted or securely archived. Users may be provided with control options to manage data collection and retention preferences, including the ability to review, restrict, or delete previously submitted data.

Method 200 begins at block 202. At block 202, one or more motion descriptions are obtained, with the motion descriptions including one or more natural-language prompts describing avatar motions. As used herein, a motion description includes any structured or unstructured input that specifies or characterizes one or more desired motions of an avatar within a virtual environment. A motion description may include natural-language text, a phonetic transcription, an audio command transcribed into text, or a multimodal input combining text and other data (e.g., visual, audio, structured text, or any combination thereof). The motion description conveys semantic information regarding the type or style of an avatar motion to be generated. For example, a motion description may include phrases such as “walk forward while turning left,” “jump over an obstacle,” or “wave hand while stepping back.” Each of the examples specifies a discrete movement sequence or gesture that can be converted into a corresponding representation for use by a motion generation model.

In some implementations, the motion descriptions include one or more natural-language prompts. A natural-language prompt includes a textual or speech-derived sequence of words expressed in a human language and used to describe an action, motion, or animation behavior. The natural-language prompt is not constrained by a predefined syntax or schema and may include descriptive modifiers, verbs, or spatial directives. For example, the natural-language prompt “a slow crouching motion transitioning to a sprint” encodes both qualitative and sequential aspects of the intended avatar motion. Natural-language prompts may be provided directly by users via an interface, automatically generated by an upstream process such as dialogue parsing, obtained from stored templates corresponding to predefined animation behaviors, or any combination thereof.

In some implementations, the avatar motions described by the natural-language prompts correspond to motion sequences that define time-varying changes in the spatial configuration of a virtual character or object within a three-dimensional coordinate space. An avatar motion can be represented as a sequence of skeletal poses, where each pose defines joint positions and orientations at a given time step. Avatar motions may include locomotion patterns (e.g., walking, running, jumping), upper-body gestures (e.g., waving, pointing, clapping), or complex compound actions composed of multiple segments (e.g., “run, then jump and land”). The system interprets the natural-language input to extract semantic information corresponding to one or more of the motion types, which are subsequently used as conditioning inputs for a generative diffusion model.

In some implementations, the obtained motion descriptions are encoded or preprocessed to produce intermediate representations suitable for downstream processing. This may include tokenization of text into semantic units, mapping of verbs and modifiers to predefined motion primitives, and generation of vector embeddings that numerically represent the semantic meaning of the natural-language prompts. The embedding may preserve relationships between related actions, enabling semantically similar prompts such as “run quickly” and “sprint” to be represented in proximate regions of an embedding space (e.g., an N-dimensional vector space, where similar vectors represent similar prompts and are closer in the N-dimensional vector space than vectors for dissimilar prompts). The resulting motion embeddings provide the basis for conditioning subsequent model operations, enabling the diffusion model to associate linguistic descriptions with corresponding temporal and spatial patterns of avatar motion. Block 202 is followed by block 204.

At block 204, the one or more motion descriptions are encoded into a motion embedding vector. As used herein, a motion embedding vector includes a numerical representation that encodes the semantic and syntactic content of a motion description into a fixed-length or variable-length vector format suitable for input to a machine learning model, such as a diffusion model. In some implementations, encoding converts text-based information into a continuous latent space in which related or similar actions or motions occupy nearby regions. The purpose of the motion embedding vector is to enable a generative diffusion model to interpret descriptive text or other symbolic inputs as quantitative conditioning information for motion generation.

In various implementations, encoding may be performed using a trained language model, a transformer-based encoder, or a specialized text-to-motion embedding network. Each input motion description, such as a natural-language prompt, is tokenized into discrete linguistic units and passed through one or more embedding layers that project each token into a high-dimensional semantic space. The token embeddings are aggregated (such as through, e.g., mean pooling, attention-based weighting, or recurrent processing) to form the motion embedding vector. The dimensionality of the vector may vary depending on the encoder architecture and, in some implementations, is selected to align with the input dimension of the downstream diffusion model.

In some implementations, the encoding incorporates auxiliary context features in addition to linguistic content. For example, data (or metadata) indicating avatar type, motion duration, or environmental context may be appended to or concatenated with the text-derived embeddings prior to projection. Environmental context may include, for example, physical or environmental conditions that influence motion characteristics, such as an avatar moving through water, a high-viscosity fluid, a low-gravity environment, or other simulated physical settings. The projection operation refers to a dimensional transformation that maps the combined embeddings into the input feature space of the downstream pre-trained diffusion model. The resulting composite embedding vector enables the downstream diffusion model to account for environmental or contextual constraints that influence motion appearance, producing a condensed multimodal feature representation that integrates both semantic meaning from the motion description and contextual attributes relevant to the motion environment.

In some implementations, the generated motion embedding vectors are stored in memory or passed directly to subsequent processing blocks as conditioning inputs for motion generation. Multiple embeddings may be produced if the original input includes several motion descriptions or sub-prompts, enabling the system to handle compound or sequential actions such as “walk, turn, and wave.” In such cases, each motion embedding vector corresponds to a distinct motion primitive and may later be processed independently by a diffusion model or used jointly in a compositional motion synthesis operation. The embedding-based representation forms the bridge between human-readable language and the continuous motion space used by the generative model (e.g., a diffusion model). Block 204 is followed by block 206.

At block 206, a noisy motion representation based on the motion embedding vector is generated, where the noisy motion representation includes a sparse set of keyframes representing skeletal poses of an avatar over time. As used herein, a noisy motion representation includes a motion signal that includes stochastic perturbations or injected noise applied to an initial motion representation in order to initiate the forward diffusion. The noisy motion representation serves as the input to a denoising diffusion model, which iteratively reconstructs a coherent motion sequence by removing the added noise across successive timesteps. The representation encodes motion information in the form of a sequence of poses corresponding to the structure of the skeletal model of the avatar (3D avatar). Each pose defines a set of parameters that specify the position and orientation of skeletal joints of the avatar relative to a local or global coordinate frame.

The noisy motion representation includes a sparse set of keyframes representing skeletal poses of an avatar over time. A sparse set of keyframes includes a subset of temporally distributed frames within a full motion sequence that are sufficient to describe the overall motion trajectory without including dense, frame-by-frame sampling. Each keyframe corresponds to a temporally distinct pose that captures a meaningful change in motion, such as the transition point between two gait cycles, a change in limb orientation, or the initiation or termination of a gesture. The sparse representation includes a lower number of total frames that are generated and refined during the diffusion (compared to a dense representation that includes a greater number of frames with lower amount of change between consecutive frames) while maintaining fidelity to the temporal dynamics of the movement of the avatar.

In some implementations, the skeletal poses represented in the noisy motion sequence define configurations of a digital skeleton that underlies the avatar mesh or rig. A skeletal pose may be represented as a collection of three-dimensional joint coordinates or joint rotation quaternions specifying the position and orientation of joints such as hips, knees, shoulders, or elbows of the avatar. In some implementations, the skeletal pose data is expressed in a hierarchical format, where the transformation of each joint is defined relative to its parent joint to preserve anatomical structure and motion continuity. The skeletal representation provides a model-agnostic format that can be adapted across different avatar proportions or rigging systems within a virtual environment or any other application in which the avatar may be depicted.

In varying implementations, noise may be introduced into the motion representation using Gaussian, uniform, or parameterized noise functions applied to the position or rotation parameters of the skeletal joints. The level of noise may correspond to a predefined timestep index that controls the magnitude of perturbation applied at a given stage of the diffusion. In certain configurations, noise is injected selectively into specific joints or subsets of the skeleton to simulate localized uncertainty, such as variation in hand or head motion while preserving stable lower-body kinematics. The generated noisy motion representation thus provides an initial input for subsequent iterative denoising and refinement operations (performed by a diffusion model) that reconstruct a consistent motion sequence from the motion embedding vector. Block 206 is followed by block 208.

At block 208, the noisy motion representation is iteratively refined using a pre-trained diffusion model over a number of timesteps. As used herein, a pre-trained diffusion model includes a probabilistic generative framework (including a neural network or equivalent) that has been trained to predict denoised motion states from noisy motion representations through a sequential refinement. During training, the pre-trained diffusion model is trained to approximate the reverse of a forward diffusion in which structured motion data is progressively corrupted by noise; essentially, the training causes the diffusion model parameters to be adjusted such that the structured motion data is recovered in a reverse diffusion. During training, the pre-trained diffusion model is trained to estimate the conditional distribution of clean motion data given noisy motion data at each timestep. The pre-trained diffusion model is trained to apply the trained denoising function across a defined number of timesteps to recover structured motion from an initially noisy representation. The training process causes parameters of the diffusion model to be adjusted such that the diffusion model is able to generate valid (e.g., realistic) structured motion data from a noisy input, with the structured motion data depicting motion that is responsive to a prompt (e.g., natural-language prompt) or other conditioning input provided to the diffusion model.

In some implementations, the pre-trained diffusion model receives the noisy motion representation and may additionally receive the motion embedding vector that provides conditioning information corresponding to text-based or contextual motion descriptions. The pre-trained diffusion model is trained to predict a denoised motion state at each iteration by estimating motion parameters consistent with the current noise level. In varying implementations, the pre-trained diffusion model may be implemented as, e.g., a temporal neural network architecture including convolutional, transformer-based, or graph-based modules that represent spatial and temporal dependencies among skeletal joints across frames. In some implementations, the parameters of the pre-trained diffusion model are established through supervised or self-supervised training using motion datasets including examples of human or avatar skeletal motion sequences and corresponding noise-corrupted variants.

The refinement is performed over a plurality of sequential timesteps, each timestep corresponding to an indexed iteration within the denoising. A timestep represents a discrete stage associated with a specific noise magnitude or variance level in a predefined noise schedule. Higher timesteps correspond to motion representations with higher levels of noise, while lower timesteps correspond to motion representations approaching the denoised state. Each iteration uses the refined motion state from the preceding timestep as input for the subsequent timestep, providing a deterministic pathway through which the pre-trained diffusion model generates a sequence of progressively less noisy motion representations.

At each timestep, the pre-trained diffusion model is applied to estimate a denoised motion representation conditioned on the noisy motion representation and the current timestep index. The pre-trained diffusion model outputs a predicted noise component, which is subtracted from or otherwise combined with the noisy input to obtain an updated motion representation corresponding to the next timestep. The iteration continues until the final timestep is reached, at which point the refined motion representation exhibits a coherent skeletal pose trajectory consistent with the motion embedding vector. In some implementations, additional conditioning signals (such as, e.g., joint velocity profiles, temporal indices, or keyframe attention weights) may be provided to the pre-trained diffusion model to preserve temporal structure and motion continuity during refinement. In various implementations, the iterations may be continued until one or more of a fixed number of timesteps are performed (e.g., based on an available computational budget and/or time constraint); change in the motion representation output at consecutive iterations falls below a change threshold (indicating that improvements/updates between iterations are minimal); and/or until another stopping criterion is met.

In some implementations, the pre-trained diffusion model includes a neural network trained to jointly process sparse keyframes and corresponding temporal indices to maintain timing consistency across motion sequences. The neural network receives as input a set of sparse keyframes representing skeletal poses and an associated sequence of temporal indices that specify the relative or absolute timing of each keyframe within the motion sequence. During training, the neural network is trained to predict denoised motion states conditioned on both pose and timing information, enabling the model to preserve phase relationships and temporal spacing among keyframes during the denoising. In various implementations, the temporal indices may be encoded as normalized scalar values, positional encodings, or learned embeddings that provide the pre-trained diffusion model with explicit awareness of frame order and motion duration. By jointly processing pose and timing data, the pre-trained diffusion model produces motion representations that maintain consistent temporal alignment and realistic rhythm across sequential frames and across different motion clips.

In some implementations, the pre-trained diffusion model is regularized using a Lipschitz-constrained loss to maintain bounded continuity of interpolated joint positions across timesteps. The Lipschitz-constrained loss restricts the rate of change of the output of the diffusion model with respect to its input. The constraint enforces temporal smoothness and numerical stability during iterative refinement, reducing abrupt discontinuities in joint trajectories between successive timesteps. The regularization term may be implemented by constraining gradient norms within the neural network or by applying spectral normalization to model parameters. By maintaining a bounded Lipschitz constant, the pre-trained diffusion model preserves continuous motion evolution across timesteps while supporting stable convergence toward the final denoised motion representation.

In some implementations, a motion dataset used to train the pre-trained diffusion model is augmented by automatically labeling unlabeled motion sequences with natural-language descriptions (assigning one or more labels to each motion sequence); and the labels are refined, e.g., using a language model. The augmentation begins with obtaining motion datasets that include unlabeled skeletal pose sequences representing various avatar movements. Each sequence is analyzed using feature extraction techniques to identify characteristic motion patterns, such as locomotion, gesture, or interaction motions. A natural-language labeling techniques is implemented that generates textual descriptions corresponding to the identified motion types, producing initial labels such as “walking forward,” “turning left,” or “raising arm.” The automatically generated labels may be subsequently refined using a trained language model that verifies linguistic consistency, removes redundancy, and/or normalizes phrasing across the dataset. The resulting labeled dataset provides paired motion-text examples suitable for training or fine-tuning the pre-trained diffusion model, enabling it to associate semantic descriptions with corresponding motion dynamics during subsequent inference operations.

In some implementations, augmenting the motion dataset includes generating a plurality of varied motion sequences by procedurally modifying the labeled motion sequences to create additional sequences having variations in motion parameters. Procedural modification may include applying controlled transformations to the original skeletal pose data, such as temporal rescaling, trajectory perturbation, or amplitude adjustment of joint rotations. The transformations alter motion attributes while preserving semantic meaning, enabling the creation of diversified examples that represent different speeds, styles, or intensities of the same underlying motion. For example, a labeled “walking” sequence may be procedurally modified to produce variations such as “slow walk,” “fast walk,” or “walk with a turn.” Additional procedural operations may include mirroring, spatial translation, or re-timing of motion frames to simulate natural variability. The resulting augmented dataset expands the range of motion patterns available during training of the pre-trained diffusion model, improving its ability to generate temporally coherent and semantically consistent motion sequences from diverse input descriptions.

In some implementations, a computer-implemented method includes obtaining one or more motion descriptions that describe avatar motions. The method further includes encoding the one or more motion descriptions into a motion embedding vector. The method further includes generating a noisy motion representation based on the motion embedding vector. The method further includes iteratively refining the noisy motion representation using a pre-trained diffusion model over a plurality of timesteps to obtain a final motion representation at the final timestep that is denoised from the noisy motion representation. The method further includes generating, based on the final motion representation, one or more motion clips defining avatar movements of the avatar and assembling the one or more motion clips into an animation controller.

In some implementations, a motion description may include one or more natural-language prompts. In some implementations, the noisy motion representation includes a sparse set of keyframes representing skeletal poses of an avatar as the avatar undergoes motion. In some implementations, the iterative refinement includes, at each timestep: estimating, a denoised motion representation based on the noisy motion representation and the current timestep; dynamically updating a keyframe mask that identifies salient keyframes of the denoised motion representation; obtaining an updated motion representation as the noisy motion representation based on the denoised motion representation and a motion representation obtained at a previous timestep; and updating the timestep. In some implementations, the keyframe mask identifies salient keyframes of the denoised motion representation based on variation in joint position or motion velocity, or a combination thereof. In some implementations, the animation controller is represented by a motion graph that specifies one or more transitions between animation states.

In some implementations, the iterative refinement process performed by the pre-trained diffusion model may be conditioned on one or more auxiliary control signals in addition to the noisy motion representation and the current timestep. For example, the refinement may incorporate spatial or kinematic constraints derived from joint angle limits or motion boundaries associated with the avatar skeleton. In certain variations, these constraints are applied selectively to the subset of sparse keyframes identified by the keyframe mask to maintain physical plausibility without constraining all joints globally across the diffusion steps.

In some implementations, both temporal alignment and keyframe weighting may be performed jointly within the same refinement step. For example, the pre-trained diffusion model may estimate updated keyframe timing indices while simultaneously updating weighting values that represent relative motion significance.

In some implementations, motion interpolation and synchronization operations may be combined into a unified post-processing stage. For example, one or more interpolation techniques, such as, e.g., spline-based interpolation or attention-driven inpainting, may be applied concurrently with synchronization of the motion clips to maintain continuity at transition boundaries. Alternatively, interpolation may precede synchronization when the motion clips are temporally aligned, or follow synchronization when blending is performed after the clips are combined.

In some implementations, the motion dataset augmentation procedures used to train the pre-trained diffusion model may include both automated labeling and procedural modification within a single adaptive pipeline. For example, unlabeled motion sequences may first be labeled using natural-language descriptions generated by a language model, after which the labeled motions may be procedurally altered through mirroring, scaling, or time-warping transformations to produce expanded motion variants. In other variations, the labeling and augmentation stages may be decoupled, with refinement of label accuracy occurring separately from generation of motion variants.

FIG. 2B is a flow diagram illustrating an example method 220 to provide iterative refinement of a noisy motion representation using a pre-trained diffusion model, in accordance with some implementations. In some implementations, method 220 may be utilized to perform iterative refinement at block 208 of method 200 of FIG. 2A. Method 220 begins at block 222.

At block 222, a denoised motion representation is estimated based on the noisy motion representation and the current timestep. The denoised motion representation is estimated by the pre-trained diffusion model configured to represent motion sequences using sparse keyframes. As used herein, a denoised motion representation includes a reconstructed motion signal generated from a noise-corrupted motion representation through application of a trained denoising function. The denoised motion representation retains the spatial and temporal structure of the underlying motion while exhibiting reduced stochastic perturbations introduced during the forward diffusion. Each denoised motion representation corresponds to a specific timestep within the iterative refinement sequence and reflects the estimated motion state after removal of the noise component predicted by the pre-trained diffusion model at that timestep.

In some implementations, the denoised motion representation is estimated by the pre-trained diffusion model configured to represent motion sequences using sparse keyframes. The pre-trained diffusion model receives, as input, the noisy motion representation and the current timestep index, and applies the trained denoising network to predict a noise estimate corresponding to the injected perturbation level at that timestep. In some implementations, the predicted noise estimate is combined with the noisy input through a deterministic update rule to produce the denoised motion representation. The pre-trained diffusion model is configured to operate on sparse keyframe-based inputs rather than densely sampled frames, enabling temporal efficiency and preservation of motion structure while limiting redundant computation across intermediate frames.

In some implementations, the pre-trained diffusion model represents motion sequences using latent variables associated with keyframe indices, joint positions, and temporal offsets. Each keyframe corresponds to a frame in the motion sequence that includes sufficient information to characterize the transition between adjacent poses. The pre-trained diffusion model processes the keyframes collectively to estimate smooth transitions across time while maintaining anatomical and kinematic consistency between joints. The sparse keyframe-based representation enables the pre-trained diffusion model to perform denoising at a higher semantic level, focusing on structurally meaningful motion variations instead of frame-level pixel or coordinate noise.

In some implementations, the estimation at each timestep produces an intermediate denoised motion representation, which is subsequently used as the input for the next refinement iteration. The degree of denoising applied depends on the timestep index, where earlier timesteps correspond to higher noise magnitudes and later timesteps correspond to near-final refinements. In certain implementations, the pre-trained diffusion model includes temporal attention or cross-frame consistency mechanisms that maintain continuity between successive keyframes during denoising. Upon completion of all timesteps, the resulting denoised motion representation represents a coherent skeletal motion sequence suitable for motion clip generation or assembly into an animation controller.

In some implementations, the noisy motion representation and the denoised motion representation each include skeletal pose data expressed as three-dimensional joint coordinates for a plurality of joints of the avatar. In some implementations, each skeletal pose defines a configuration of the articulated structure of the avatar at a given point in time, where individual joints, such as hips, knees, shoulders, and elbows, are represented by coordinate triplets (x, y, z) in a local or global reference frame. The noisy motion representation includes stochastic perturbations applied to the joint coordinates to simulate the forward diffusion, while the denoised motion representation includes corresponding joint coordinates refined by the pre-trained diffusion model through iterative denoising. The use of three-dimensional joint coordinates enables the pre-trained diffusion model to operate directly in geometric space, preserving spatial relationships among joints and enabling consistent reconstruction of motion trajectories across frames. In some implementations, the representation format is compatible with standard animation rigs and can be directly integrated into downstream rendering or avatar control systems. Block 222 is followed by block 224.

At block 224, a keyframe mask is dynamically updated. The keyframe mask identifies salient keyframes of the denoised motion representation based on variation in joint position or motion velocity over time. As used herein, a keyframe mask includes a structured data element, such as a binary or weighted array, that indicates which frames within a motion sequence are designated as keyframes for use in sparse motion representation or subsequent processing. Each element in the keyframe mask corresponds to a frame index within the denoised motion representation and includes a value specifying whether that frame is included as a keyframe or assigned a level of salience. The keyframe mask serves as a control mechanism for selectively focusing computational and model resources on frames that exhibit meaningful temporal or spatial changes while disregarding redundant frames with minimal variation.

In some implementations, the salient keyframes identified by the keyframe mask correspond to frames that capture significant motion events or transitions within the denoised motion representation. A salient keyframe may represent a moment in the motion sequence where the configuration of skeletal joints changes substantially relative to preceding or subsequent frames. For example, salient keyframes may occur at the initiation of a step in a walking sequence, at the apex of a jump, or at the moment of contact in a gesture such as waving. The keyframes define the temporal anchors of the motion and enable the pre-trained diffusion model to operate on a reduced but informative subset of the full motion sequence.

In some implementations, dynamic updating of the keyframe mask includes recalculating the salience values of frames based on observed changes in joint position or motion velocity across time. In some implementations, frame-wise variation metrics are computed by determining the Euclidean distance or angular displacement of corresponding joints between adjacent frames. Motion velocity may be estimated as the first derivative of joint positions over time. Frames that exceed predefined variation thresholds are marked or weighted as salient in the keyframe mask. The update enables the motion representation to adapt dynamically as the denoised motion evolves across timesteps.

In some implementations, dynamically updating the keyframe mask includes weighting keyframes based on magnitude of joint displacement or temporal motion energy. The weighting operation assigns a numerical importance value to each frame within the denoised motion representation according to its relative contribution to overall motion dynamics. The magnitude of joint displacement may be determined by computing the cumulative Euclidean distance traversed by each skeletal joint between consecutive frames, while temporal motion energy may be derived from the squared velocity or acceleration of joint trajectories over time. Frames exhibiting higher displacement or energy values are assigned proportionally greater weights in the keyframe mask, indicating greater salience for subsequent denoising or interpolation operations. The weighted representation enables the pre-trained diffusion model to focus refinement on temporally active regions of the motion sequence, while less dynamic intervals receive lower emphasis during the iterative update. Block 224 is followed by block 226.

At block 226, an updated motion representation is obtained as the noisy motion representation, based on the denoised motion representation and a motion representation obtained at a previous timestep. In some implementations, the updated motion representation includes the intermediate motion state generated at each iteration of the diffusion that combines the effects of denoising with residual stochastic noise introduced during the iterative refinement process. The updated motion representation maintains temporal continuity with prior iterations while incrementally reducing the influence of stochastic noise in accordance with the noise schedule of the pre-trained diffusion model. The updated motion representation serves as the input noisy motion representation for the subsequent timestep in the iterative sequence.

In some implementations, the updated motion representation is obtained by combining the denoised motion representation produced at the current timestep with the motion representation from the immediately preceding timestep according to a deterministic update rule. In one example configuration, the update rule includes a linear combination of the denoised motion representation and the previous motion representation weighted by coefficients determined by the diffusion noise variance schedule. The diffusion noise variance schedule defines the proportional contribution of the denoised and residual components at each timestep, enabling a controlled transition from high-noise to low-noise states. The update rule may incorporate scaling factors or bias terms to preserve stability and maintain consistent motion trajectories across successive refinement iterations.

In some implementations, the resulting updated motion representation retains both the structural information captured by the denoised motion representation and the stochastic diversity inherent to the diffusion. The representation may include, e.g., pose parameters, joint coordinates, or latent variables corresponding to skeletal configurations over time. By maintaining partial noise during intermediate iterations, the pre-trained diffusion model preserves variability that enables subsequent timesteps to refine motion details rather than overfitting to early estimates. Each updated motion representation thus represents a progressive step toward the final denoised motion sequence.

In some implementations, the update operation is performed in latent space (e.g., embedding space or vector space) rather than in the direct coordinate space of the skeletal joints. In such cases, the pre-trained diffusion model encodes both the denoised and previous motion representations into a latent domain where arithmetic operations are applied to produce the updated representation, which is decoded back into skeletal pose parameters. The described implementations have numerical stability and efficient convergence during the iterations. Regardless of representation domain, the updated motion representation establishes continuity between successive timesteps and provides the evolving motion state used for further refinement until the final denoised motion sequence is obtained. Block 226 is followed by block 228.

At block 228, the timestep is updated to advance the iterative refinement of the pre-trained diffusion model. Updating the timestep includes incrementing or decrementing the timestep index according to the defined schedule, thereby advancing the process from the current refinement stage to the next. The transition between timesteps defines the iterative progression through which the pre-trained diffusion model reduces the influence of stochastic noise and converges toward a coherent motion representation.

In some implementations, one or more of blocks 222-228 may be performed by one or more server devices, and one or more of blocks 222-228 may be performed by one or more client devices. In some implementations, all of method 220 may be performed by a server device, or by a client device. In some implementations, block 222, block 224, or block 226 may be omitted. In some implementations, one or more of blocks 222-228 may be performed in parallel. In some implementations, blocks 222 and 224 may be performed in parallel. In some implementations, blocks 226 and 228 may be performed in parallel.

Returning to FIG. 2A, block 208 is followed by block 210. At block 210, a final motion representation is obtained corresponding to a last timestep of the iterative refinement. As used herein, a final motion representation includes the motion state produced after the completion of all denoising iterations performed by the pre-trained diffusion model. The representation is derived from the last timestep, at which the level of residual noise defined by the noise schedule approaches zero or a value that is below a noise threshold. The final motion representation encapsulates the spatial and temporal structure of a movement sequence of an avatar as predicted by the diffusion, including pose parameters that define joint positions and orientations across time. The representation serves as a fully refined motion signal that can be directly converted into one or more motion clips or used for synthesis of animation controllers.

In some implementations, the final motion representation may be expressed in a parameterized form that captures the skeletal configuration of the avatar. Each frame within the representation specifies the three-dimensional coordinates or joint rotation quaternions for the relevant joints of the avatar skeleton. The temporal arrangement of the frames defines the motion trajectory over time. In some implementations, the final motion representation is stored as a sparse keyframe sequence where frames identified as salient are retained, and non-keyframes are interpolated during motion clip generation. The resulting representation thereby encodes essential motion characteristics while maintaining compatibility with animation retargeting systems or runtime playback pipelines.

In some implementations, obtaining the final motion representation includes reading the output of the last refinement iteration and normalizing the resulting motion parameters to remove one or more of residual drift, coordinate scaling errors, and/or discontinuities between adjacent frames. Normalization may include spatial alignment to a fixed reference coordinate frame, resampling of temporal intervals to achieve uniform frame spacing, and/or smoothing of joint trajectories to eliminate numerical artifacts introduced during denoising. The post-processing operations convert the final model output into a consistent data format that can be efficiently stored, visualized, or transmitted for subsequent processing.

Once the final motion representation is obtained, it can be used as the foundational input for constructing motion clips or generating animation controllers. In some implementations, the final motion representation may be decomposed into multiple motion primitives, each representing a specific segment of the overall motion sequence, such as walking, turning, or gesturing. The motion primitives can be aligned, synchronized, or combined to form higher-level animation behaviors. The final motion representation therefore constitutes the terminal output of the diffusion-based refinement and serves as the motion-level data structure from which higher-order animation systems derive their control logic and playback configurations. Block 210 is followed by block 212.

At block 212, one or more motion clips defining avatar movements are generated based on the final motion representation. In some implementations, a motion clip includes a discrete temporal segment of motion data that defines a continuous sequence of avatar poses over a specified time interval. Each motion clip corresponds to a distinct motion behavior, such as walking, jumping, crouching, or waving, and may be represented as a series of skeletal joint positions, joint rotations, or other kinematic parameters derived from the final motion representation. The motion clips generated at this stage form the building blocks for subsequent assembly into animation controllers or composite motion graphs.

In some implementations, generation of motion clips includes segmenting the final motion representation into one or more temporal intervals according to motion boundaries or keyframe indices. In some implementations, segmentation is performed by detecting points in the motion trajectory where the velocity, acceleration, or joint configuration of the avatar exhibits a marked change. The segmentation points define the start and end boundaries of individual motion clips. Each segment is stored as a separate motion clip, preserving its associated timing information, pose sequence, and skeletal hierarchy. The resulting clips represent temporally bounded motion units suitable for reuse, synchronization, or composition with other generated or preexisting animations.

In some implementations, additional metadata may be associated with each generated motion clip. Such metadata can include descriptive labels derived from the motion description or motion embedding vector, parameters identifying the duration or playback speed, and motion constraints defining positional limits or end-effector contact conditions. The inclusion of metadata enables the motion clips to be indexed and retrieved for subsequent recombination or blending operations. For example, a motion clip generated from a description such as “step forward and raise right arm” may include metadata identifying it as a “step” motion with an “upper-body gesture” modifier, enabling contextual use during animation synthesis.

In some implementations, the generated motion clips preserve the spatial and temporal coherence of the final motion representation while enabling flexible manipulation within animation pipelines. In some implementations, interpolation or temporal resampling may be performed to standardize frame rates or adapt motion duration across clips. Individual motion clips may undergo optional filtering to remove residual artifacts or to enable consistency in skeletal alignment between consecutive clips. The resulting set of motion clips provides a modular representation of avatar movement that can be further processed, synchronized, or assembled into higher-order structures such as animation controllers or state-transition graphs for runtime execution.

In some implementations, using at least one secondary pre-trained diffusion model, one or more additional motion clips are generated that are temporally aligned with the one or more motion clips generated by the pre-trained diffusion model to form a combined set of motion clips. The secondary pre-trained diffusion model may be trained or fine-tuned to produce motion sequences complementary to those generated by the primary model, such as upper-body gestures synchronized with lower-body locomotion or secondary movements like head orientation or hand articulation. In some implementations, temporal alignment between the motion clips is achieved by associating corresponding frame indices, timestamps, or phase parameters across the generated sequences to enable consistent timing and coordination of skeletal motion. The combined set of motion clips represents a unified motion dataset in which multiple concurrent or hierarchical motions are synchronized for integration into a single animation controller or composited sequence.

In some implementations, based on identified transition points between the combined set of motion clips, one or more intermediate motion frames are generated using one or more interpolation techniques. The transition points correspond to temporal or spatial boundaries between consecutive motion clips where differences in joint configuration, root position, or motion phase are detected. To achieve continuity across the boundaries between consecutive motion clips, interpolation techniques such as linear interpolation, spline interpolation, or motion-inbetweening based on kinematic constraints are applied to generate intermediate frames. Each intermediate motion frame defines interpolated skeletal joint coordinates that smoothly connect the end pose of a preceding motion clip with the start pose of a subsequent motion clip. In some implementations, the interpolation is performed selectively on subsets of joints to preserve contact stability or motion intent, such as maintaining foot placement during locomotion transitions. The resulting interpolated frames bridge discontinuities across clips, enabling coherent temporal blending and seamless motion playback within the combined motion sequence.

In some implementations, the combined set of motion clips are synchronized using the one or more intermediate motion frames to obtain synchronized motion clips, and the synchronized motion clips are assembled into an animation controller represented by a motion graph specifying one or more transitions between animation states. In some implementations, synchronization includes adjusting temporal alignment and pose continuity among the motion clips so that transitions occur without perceptible discontinuities in position, orientation, or timing. The intermediate motion frames generated between transition points serve as bridging data, enabling the endpoint of one clip and the starting point of the next to share consistent skeletal configurations and motion velocities. Once synchronization is achieved, the resulting motion clips are designated as synchronized motion clips. The synchronized motion clips are provided as input for construction of an animation controller, where their temporal and spatial relationships are organized into a motion graph defining state transitions. The specific process of assembling the synchronized motion clips into the animation controller is described in further detail with respect to block 214. Block 212 is followed by block 214.

At block 214, the one or more motion clips are assembled into an animation controller represented by a motion graph specifying one or more transitions between animation states. In some implementations, an animation controller includes a data structure or runtime component that governs the sequencing, blending, and playback of animation clips for an avatar within a virtual environment. The animation controller defines the logical and temporal relationships among multiple motion clips, determining how transitions occur between them in response to user input, scripted logic, or system-level conditions. The motion graph representation of the animation controller provides a formalized structure in which animation states correspond to motion clips, and edges between states define permissible transitions and associated blending operations.

In some implementations, assembling the animation controller includes creating graph nodes corresponding to each motion clip generated at block 212 and establishing edges that specify transition conditions between nodes. Each node in the motion graph represents a discrete animation state, such as “idle,” “walk,” “run,” or “jump.” Transition edges are defined according to motion continuity metrics, temporal alignment, or semantic relationships derived from the original motion descriptions. For example, a transition from “walk” to “run” may be defined based on the similarity of end and start poses between the corresponding motion clips or the velocity threshold of the avatar. Each transition is associated with a blending interval or interpolation scheme that determines how the motion clips are merged during playback.

In some implementations, the assembly includes automatic synchronization of motion clips to enable consistent timing and positional alignment at transition boundaries. This may include normalizing root joint positions, adjusting clip durations, and/or computing intermediate transition frames to reduce discontinuities. The motion graph may encode conditional logic parameters that determine transition activation based on external triggers, such as control inputs, environment interactions, or procedural animation events. The animation controller thus captures both the spatial relationships among motion clips and the dynamic behaviors for responsive avatar animation in interactive environments.

In some implementations, the animation controller serves as an executable framework for real-time or precomputed animation playback. In some implementations, the motion graph can be exported to or instantiated within a runtime animation system, such as a compositor or state machine, which interprets the graph to update avatar pose data during execution. The motion graph structure supports modular editing, enabling additional motion clips or transitions to be integrated without retraining or reinitializing the diffusion model. By representing motion logic explicitly through graph connections, the assembled animation controller provides a scalable mechanism for managing complex avatar motion behaviors derived from diffusion-based motion synthesis.

In some implementations, one or more of blocks 202-214 may be performed by one or more server devices, and one or more of blocks 202-214 may be performed by one or more client devices. In some implementations, all of method 200 may be performed by a server device, or by a client device. In some implementations, one or more of blocks 202-214 may be performed in parallel. For example, in some implementations, blocks 202 and 206 may be performed in parallel.

In various implementations, the techniques described herein may include combinations of one or more features recited in the claims. For example, in some implementations, a computer-implemented method includes obtaining one or more motion descriptions including one or more natural-language prompts describing avatar motions. The one or more motion descriptions are encoded into a motion embedding vector. A noisy motion representation is generated based on the motion embedding vector, where the noisy motion representation includes a sparse set of keyframes representing skeletal poses of an avatar over time. The noisy motion representation is iteratively refined using a pre-trained diffusion model over a plurality of timesteps. The iterative refinement includes, at each timestep, estimating, by the pre-trained diffusion model configured to represent motion sequences using sparse keyframes, a denoised motion representation based on the noisy motion representation and the current timestep, dynamically updating a keyframe mask that identifies salient keyframes of the denoised motion representation based on variation in joint position or motion velocity over time, obtaining an updated motion representation as the noisy motion representation based on the denoised motion representation and a motion representation obtained at a previous timestep, and updating the timestep. A final motion representation corresponding to a last timestep of the iterative refinement is obtained. Based on the final motion representation, one or more motion clips defining avatar movements of the avatar are generated, and the one or more motion clips are assembled into an animation controller represented by a motion graph specifying one or more transitions between animation states.

In some implementations, dynamically updating the keyframe mask includes weighting keyframes based on magnitude of joint displacement or temporal motion energy. In some implementations, the pre-trained diffusion model includes a neural network trained to jointly process sparse keyframes and corresponding temporal indices to maintain timing consistency across motion sequences. In some implementations, these two aspects are combined such that dynamically updating the keyframe mask includes weighting keyframes based on magnitude of joint displacement or temporal motion energy, while the pre-trained diffusion model is trained to jointly process sparse keyframes and corresponding temporal indices to maintain timing consistency across motion sequences.

In some implementations, the noisy motion representation and the denoised motion representation each include skeletal pose data expressed as three-dimensional joint coordinates for a plurality of joints of the avatar. In some implementations, the aspects of dynamically updating the keyframe mask based on magnitude of joint displacement or temporal motion energy, or jointly processing sparse keyframes and temporal indices, are combined with the three-dimensional skeletal pose representations of the avatar.

In some implementations, one or more additional motion clips that are temporally aligned with the one or more motion clips generated by the pre-trained diffusion model are generated using at least one secondary pre-trained diffusion model to form a combined set of motion clips. In some implementations, based on identified transition points between the combined set of motion clips, one or more intermediate motion frames are generated using one or more interpolation techniques. In some implementations, the combined set of motion clips are synchronized using the one or more intermediate motion frames to obtain synchronized motion clips, and the synchronized motion clips are assembled into the animation controller represented by the motion graph specifying one or more transitions between animation states. Any of these implementations can be used alone or in combination, such as generating intermediate motion frames using interpolation techniques together with synchronizing the combined motion clips for integration into the animation controller.

In some implementations, the pre-trained diffusion model is regularized using a Lipschitz-constrained loss to maintain bounded continuity of interpolated joint positions across two or more timesteps of the plurality of timesteps. This feature may be combined with any of the implementations described above, for example with dynamic keyframe weighting, temporal alignment of motion clips, or interpolation-based synchronization.

In some implementations, a motion dataset used to train the pre-trained diffusion model is augmented by automatically assigning labels to unlabeled motion sequences with natural-language descriptions and refining the labels using a language model. In some implementations, augmenting the motion dataset includes generating a plurality of varied motion sequences by procedurally modifying the unlabeled motion sequences to create additional sequences having variations in motion parameters. In some implementations, both automated labeling using natural-language descriptions and procedural dataset augmentation with motion variations are applied together to improve the diversity and label consistency of the training dataset used for the pre-trained diffusion model.

Any of the described combinations can be implemented in various contexts. For example, dynamic keyframe weighting may be used independently or jointly with Lipschitz-constrained regularization of the diffusion model; three-dimensional skeletal pose encoding may be combined with the generation of temporally aligned motion clips; or interpolation-based synchronization may be performed with or without procedural augmentation of the training dataset. The individual and combined features described herein may be applied across different hardware or software configurations, including implementations in which the operations are performed by a virtual experience engine, a graphics engine, or a virtual experience application executing on a client or server system.

FIG. 3 illustrates an example method 300 for creating an animation controller, in accordance with some implementations. As shown, a set of motion descriptions is processed to produce multiple motion clips that can be assembled into an animation controller represented as a motion graph and integrated with a compositor application programming interface (API) of a virtual experience engine. The animation controller defines the transitions between animation states, such as walking, running, jumping, and falling, each corresponding to a motion clip generated or refined through diffusion-based synthesis.

Generation of the animation controller begins with receiving a composite natural-language query describing multiple related avatar motions. A prompt parser decomposes the input query into a set of motion sub-prompts corresponding to individual motion primitives. For example, a high-level query such as “locomotion controller with walk-run-jump-fall” may be decomposed into sub-prompts such as “walk forward slowly,” “turn right while walking forward,” “run backward,” “jump in place,” “suddenly fall down,” and “get up to idle pose.” Each sub-prompt represents a motion description that is used to condition diffusion-based motion generation.

A pre-trained diffusion model is used as the generative mechanism for producing motion clips from the parsed sub-prompts. The diffusion model generates motion representations using sparse keyframes that capture skeletal pose variations over time. During generation, constraints such as loop continuity, temporal alignment, and/or contact stability may be applied to maintain consistency across motion categories. In some implementations, separate instances of the pre-trained diffusion model are applied to generate different groups of motions. For example, a set of models collectively referred to as LeaderGen may be configured to generate stable, frequently used motion categories such as walking or turning, while another set of models collectively referred to as FollowerGen may be configured to generate complementary or transitional motions such as jumping, falling, or returning to idle.

The outputs of the LeaderGen and FollowerGen diffusion models are combined and aligned to produce a cohesive set of motion clips. Leader-generated motions serve as temporal and kinematic references, while follower motions are temporally adjusted and refined to maintain continuity with the leader motions. In some implementations, phase synchronization techniques are applied to enable overlapping or adjacent motion clips to exhibit consistent gait phase and body orientation. The synchronization may include adjusting temporal offsets or root joint trajectories to make the motion clips able to be directly blended within the animation controller framework.

When transitions between motion clips include additional intermediate frames, motion in-betweening is performed to generate bridging sequences between pairs of motions. Transition points are identified between clips such as “turn right while walking forward” and “run backward,” or between “run backward” and “jump in place.” The in-betweening generates intermediate motion frames that maintain continuity of skeletal pose and motion velocity between the adjacent clips. The phase synchronization and in-betweening operations enable the generated motion clips to be composed seamlessly within the same temporal structure.

The synchronization and in-betweening operations are performed using one or more pre-trained diffusion models configured for pairwise refinement of motion sequences. Mixed-attention mechanisms may be used to align feature representations across the motion pairs, while motion inpainting techniques are used to infer missing or transitional poses between two temporally adjacent motion clips. The resulting synchronized and interpolated motion sequences are passed to a compositor API that constructs the final animation controller, where each motion clip is represented as a state node and transitions are defined based on the generated phase-aligned motion data.

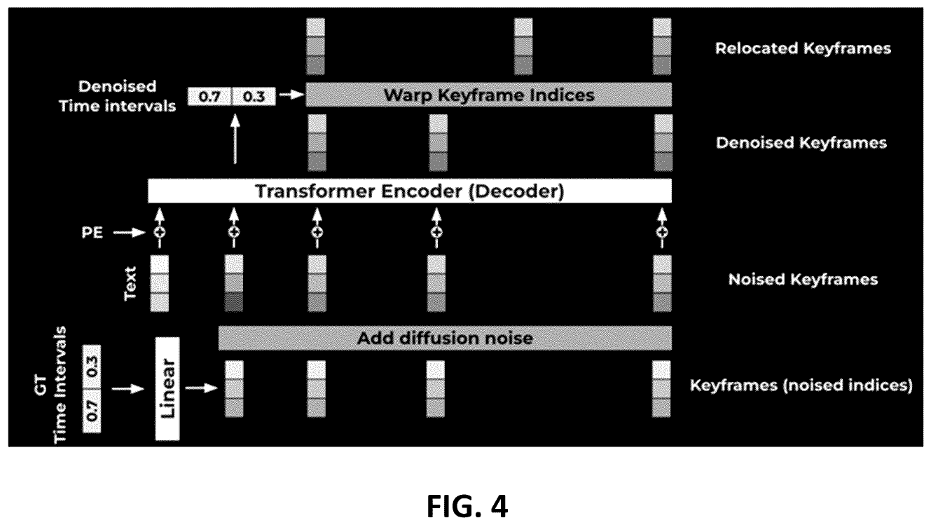

FIG. 4 illustrates an example of a motion keyframes diffusion model (MKDM), in accordance with some implementations. The illustrated system represents an instance of the pre-trained diffusion model configured to process motion sequences expressed as sparse keyframes associated with temporal indices. The MKDM applies iterative refinement over timesteps to reconstruct coherent motion trajectories from noise-corrupted keyframe representations. As shown, keyframes are first associated with ground-truth time intervals and corresponding indices, which are perturbed with controlled diffusion noise to produce noisy keyframes. The pre-trained diffusion model, implemented as a transformer-based encoder-decoder architecture, processes the noisy keyframes to estimate denoised motion states and reconstruct temporally consistent skeletal poses.

The MKDM is trained to represent motion sequences as sparse sets of keyframes located at non-uniform time intervals. Sparse keyframes refer to selected frames that capture meaningful changes in motion, identified using a keyframe reduction or salience-based selection techniques. Each keyframe encodes three-dimensional joint positions or rotations for a plurality of joints in the avatar skeleton. Associated time intervals are represented as continuous values that define relative spacing between adjacent keyframes. Unlike dense motion representations that sample every frame at a fixed rate, the sparse formulation enables the pre-trained diffusion model to process compact motion data while preserving semantic and temporal structure. The model is trained using paired textual and motion data such that the text embeddings and keyframe embeddings jointly represent the relationship between natural-language descriptions and corresponding motion trajectories.

During training and inference, noise is applied to the keyframe data, producing noisy keyframes that serve as input to the pre-trained diffusion model. The transformer encoder-decoder predicts denoised keyframes conditioned on both the noisy inputs and their temporal indices. A timestep-dependent noise schedule controls the variance of injected noise at each iteration. The model output includes denoised keyframes and optionally relocated keyframe indices that preserve phase relationships across motion sequences. To maintain bounded continuity across timesteps, a Lipschitz-constrained regularization term may be applied during training to limit the rate of change between predicted keyframe positions. The structure enables the pre-trained diffusion model to generate temporally consistent keyframe trajectories across successive denoising iterations.

In some implementations, the pre-trained diffusion model utilizes a warping mechanism to align denoised keyframes to their corresponding time intervals. The time intervals are dynamically adjusted through a linear mapping or learned function that accounts for differences between noisy and denoised temporal indices. In some implementations, positional encodings derived from the text embeddings and ground-truth intervals are integrated into the transformer layers to preserve alignment between semantic cues and motion timing. The resulting denoised motion representation consists of relocated keyframes arranged at corrected temporal intervals, which can subsequently be interpolated to reconstruct continuous motion sequences suitable for motion clip generation and controller assembly as described in connection with FIG. 3.

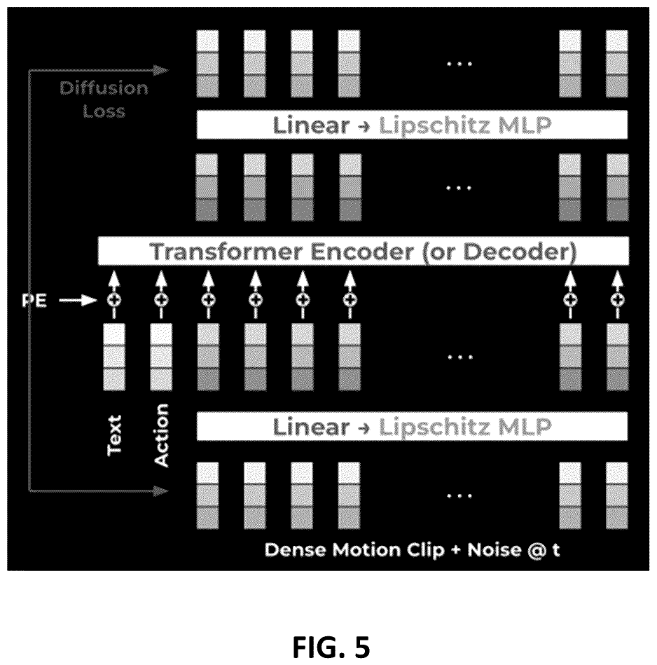

FIG. 5 is a flow diagram illustrating an example of using a Lipschitz multilayer perceptron (MLP) to improve the smoothness of manifold embedding in pose representations for frames, in accordance with some implementations. The illustrated architecture enables simultaneous refinement of both keyframe pose values and their associated temporal indices. The pre-trained diffusion model operates on dense motion clips with injected noise corresponding to the current timestep and predicts denoised motion states in a temporally coherent order. The architecture enables joint denoising of keyframe positions and temporal locations, enabling reconstructed keyframes to be properly aligned along a continuous and physically plausible motion timeline.

As shown, the network includes a transformer encoder-decoder structure coupled with one or more Lipschitz-constrained multilayer perceptrons (MLPs). The transformer layers process encoded representations of textual and motion conditioning inputs, with positional encodings (PE) used to maintain temporal and semantic correspondence across timesteps. The input layer projects noisy keyframe data and corresponding conditioning vectors through a linear transformation followed by a Lipschitz MLP, while the output layer reconstructs denoised motion states using a similar configuration. The Lipschitz constraint enforces bounded gradients during training, preserving continuity in the mapping between latent pose embeddings and reconstructed motion outputs.

During training, the pre-trained diffusion model is trained to reduce a diffusion loss between the predicted denoised motion representation and ground-truth dense motion sequences. The use of Lipschitz MLPs at both the encoder and decoder boundaries regularizes the model by constraining the smoothness of latent interpolations across successive timesteps. The constraint helps maintain consistent joint displacement continuity, reducing abrupt motion transitions during iterative denoising. The architecture removes reliance on external keyframe reduction techniques by enabling direct reconstruction of dense motion frames from noisy or sparse input representations, providing a unified model that represents both temporal and pose-space continuity within the same diffusion.

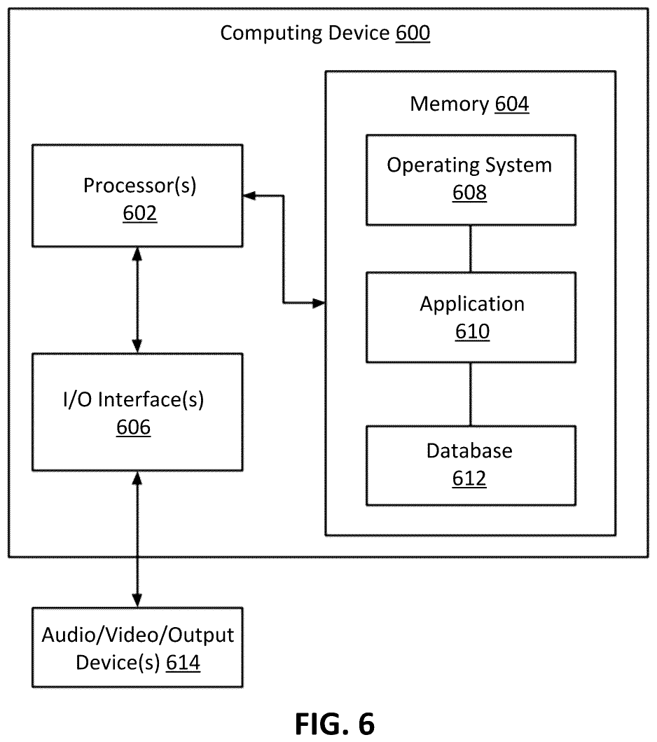

FIG. 6 is a block diagram of an example computing device 600 which may be used to implement one or more techniques described herein. In one example, device 600 may be used to implement a computer device (e.g., 102 and/or 110 of FIG. 1), and perform method implementations described herein. Computing device 600 can be any suitable computer system, server, or other electronic or hardware device. For example, the computing device 600 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 600 includes a processor 602, a memory 604, input/output (I/O) interface 606, and audio/video input/output devices 614.

Processor 602 can be one or more processors and/or processing circuits to execute program code and control basic operations of the device 600. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “near-real-time”, “offline,” in a “batch mode,” etc. Portions of processing may be performed at different times and at different locations, by different (or the same) processing systems. A computer may be any processor in communication with a memory.

Memory 604 is provided in device 600 for access by the processor 602, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 602 and/or integrated therewith. Memory 604 can store software operating on the server device 600 by the processor 602, including an operating system 607, one or more applications 610, and a database 612 that may store data used by the components of device 600.

Database 612 may store data and configurations used for generating animation controllers within a virtual environment. The stored information may include motion datasets, keyframe representations, motion embedding vectors, and trained parameter sets associated with one or more pre-trained diffusion models. In some implementations, database 612 may maintain records for motion clips generated from sparse keyframe-based motion representations, including unique identifiers, spatial and temporal metadata, and synchronization data describing transition points between clips. Additional stored data may include natural-language prompts or motion descriptions used during motion generation, intermediate denoised motion representations produced during iterative refinement, and associated keyframe masks identifying salient frames. The database may further store configuration data for procedural motion dataset augmentation, interpolation parameters for generating intermediate motion frames, and session-level data specifying animation controller states and corresponding motion graph structures. Applications 610 may include executable instructions that, when processed by processor 602, perform operations such as generating motion clips via pre-trained diffusion models, updating and synchronizing motion sequences based on keyframe continuity, and assembling motion clips into animation controllers represented by motion graphs.

For example, applications 610 may include one or more modules that execute the described techniques for automated generation of animation controllers. The modules may perform operations such as generating motion clips based on motion descriptions, synchronizing transitions between motion clips, and managing sparse keyframe-based motion representations derived from pre-trained diffusion models. In some implementations, applications 610 can monitor the temporal and spatial alignment of generated motion clips to maintain continuity between denoised motion representations and interpolated motion frames. The modules may evaluate motion characteristics to determine transition boundaries and adjust synchronization parameters between animation states. Additional processing logic can apply context-dependent rules for blending or sequencing motion clips within an animation controller represented by a motion graph. Database 612, or an associated storage system, may store data accessed by the modules, including motion clip metadata, denoised keyframe indices, keyframe masks, synchronization parameters, interpolation coefficients, and configuration settings for constructing or updating animation controllers.

Elements of software in memory 604 can alternatively be stored on any other suitable storage location or computer-readable medium. In addition, memory 604 (and/or other connected storage device(s)) can store instructions and data used in the features described herein. Memory 604 and any other type of storage (magnetic disk, optical disk, magnetic tape, or other tangible media) can be considered “storage” or “storage devices.”

I/O interface 606 can provide functions to enable interfacing the server device 600 with other systems and devices. For example, network communication devices, storage devices (e.g., memory and/or data store 120), and input/output devices can communicate via interface 606. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 614 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 6 shows one block for each of processor 602, memory 604, I/O interface 606, and software blocks of operating system 608 and virtual experience application 610. The blocks may represent one or more processors or processing circuitries, operating systems, memories, I/O interfaces, applications, and/or software engines. In other implementations, device 600 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 600 can be a server device or client device. Example client devices or user devices can be computer devices including some similar components as the device 600, e.g., processor(s) 602, memory 604, and I/O interface 606. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 614, for example, can be connected to (or included in) the device 600 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
obtaining one or more motion descriptions comprising one or more natural-language prompts describing avatar motions;
encoding the one or more motion descriptions into a motion embedding vector;
generating a noisy motion representation based on the motion embedding vector, wherein the noisy motion representation comprises a sparse set of keyframes representing skeletal poses of an avatar over time;
iteratively refining the noisy motion representation using a pre-trained diffusion model over a plurality of timesteps, wherein the iterative refinement comprises, at each timestep:
estimating, by the pre-trained diffusion model configured to represent motion sequences using sparse keyframes, a denoised motion representation based on the noisy motion representation and the current timestep;
dynamically updating a keyframe mask that identifies salient keyframes of the denoised motion representation based on variation in joint position or motion velocity over time;
obtaining an updated motion representation as the noisy motion representation based on the denoised motion representation and a motion representation obtained at a previous timestep; and
updating the timestep;
obtaining a final motion representation corresponding to a last timestep of the iterative refinement;
generating, based on the final motion representation, one or more motion clips defining avatar movements of the avatar; and
assembling the one or more motion clips into an animation controller represented by a motion graph specifying one or more transitions between animation states.

2. The computer-implemented method of claim 1, wherein dynamically updating the keyframe mask comprises weighting keyframes based on magnitude of joint displacement or temporal motion energy.

3. The computer-implemented method of claim 1, wherein the pre-trained diffusion model comprises a neural network trained to jointly process sparse keyframes and corresponding temporal indices to maintain timing consistency across motion sequences.

4. The computer-implemented method of claim 1, wherein the noisy motion representation and the denoised motion representation each comprise skeletal pose data expressed as three-dimensional (3D) joint coordinates for a plurality of joints of the avatar.

5. The computer-implemented method of claim 1, further comprising:
generating, using at least one secondary pre-trained diffusion model, one or more additional motion clips that are temporally aligned with the one or more motion clips generated by the pre-trained diffusion model to form a combined set of motion clips.

6. The computer-implemented method of claim 5, further comprising:
generating, based on identified transition points between the combined set of motion clips, one or more intermediate motion frames using one or more interpolation techniques.

7. The computer-implemented method of claim 6, further comprising:
synchronizing the combined set of motion clips using the one or more intermediate motion frames to obtain synchronized motion clips; and
assembling the synchronized motion clips into the animation controller represented by the motion graph specifying one or more transitions between animation states.

8. The computer-implemented method of claim 1, wherein the pre-trained diffusion model is regularized using a Lipschitz-constrained loss to maintain bounded continuity of interpolated joint positions across two or more timesteps of the plurality of timesteps.

9. The computer-implemented method of claim 1, further comprising:
augmenting a motion dataset used to train the pre-trained diffusion model by automatically assigning labels to unlabeled motion sequences with natural-language descriptions; and
refining the labels using a language model.

10. The computer-implemented method of claim 9, wherein augmenting the motion dataset further comprises generating a plurality of varied motion sequences by procedurally modifying the unlabeled motion sequences to create additional sequences having variations in motion parameters.

11. A computing device comprising:
one or more processors; and
memory coupled to the one or more processors with instructions stored thereon that, when executed by the one or more processors, cause the one or more processors to perform operations comprising:
obtaining one or more motion descriptions comprising one or more natural-language prompts describing avatar motions;
encoding the one or more motion descriptions into a motion embedding vector;
generating a noisy motion representation based on the motion embedding vector, wherein the noisy motion representation comprises a sparse set of keyframes representing skeletal poses of an avatar over time;
iteratively refining the noisy motion representation using a pre-trained diffusion model over a plurality of timesteps, wherein the iterative refinement comprises, at each timestep:
estimating, by the pre-trained diffusion model configured to represent motion sequences using sparse keyframes, a denoised motion representation based on the noisy motion representation and the current timestep;
dynamically updating a keyframe mask that identifies salient keyframes of the denoised motion representation based on variation in joint position or motion velocity over time;
obtaining an updated motion representation as the noisy motion representation based on the denoised motion representation and a motion representation obtained at a previous timestep; and
updating the timestep;
obtaining a final motion representation corresponding to a last timestep of the iterative refinement;
generating, based on the final motion representation, one or more motion clips defining avatar movements of the avatar; and
assembling the one or more motion clips into an animation controller represented by a motion graph specifying one or more transitions between animation states.

12. The computing device of claim 11, wherein dynamically updating the keyframe mask comprises weighting keyframes based on magnitude of joint displacement or temporal motion energy.

13. The computing device of claim 11, wherein the pre-trained diffusion model comprises a neural network trained to jointly process sparse keyframes and corresponding temporal indices to maintain timing consistency across motion sequences.

14. The computing device of claim 11, wherein the noisy motion representation and the denoised motion representation each comprise skeletal pose data expressed as three-dimensional (3D) joint coordinates for a plurality of joints of the avatar.

15. The computing device of claim 1, wherein the instructions cause the one or more processors to perform a further operation comprising:
generating, using at least one secondary pre-trained diffusion model, one or more additional motion clips that are temporally aligned with the one or more motion clips generated by the pre-trained diffusion model to form a combined set of motion clips.

16. A non-transitory computer-readable medium with instructions stored thereon that, when executed by a processor, cause the processor to perform operations comprising:
obtaining one or more motion descriptions comprising one or more natural-language prompts describing avatar motions;
encoding the one or more motion descriptions into a motion embedding vector;
generating a noisy motion representation based on the motion embedding vector, wherein the noisy motion representation comprises a sparse set of keyframes representing skeletal poses of an avatar over time;
iteratively refining the noisy motion representation using a pre-trained diffusion model over a plurality of timesteps, wherein the iterative refinement comprises, at each timestep:
estimating, by the pre-trained diffusion model configured to represent motion sequences using sparse keyframes, a denoised motion representation based on the noisy motion representation and the current timestep;
dynamically updating a keyframe mask that identifies salient keyframes of the denoised motion representation based on variation in joint position or motion velocity over time;
obtaining an updated motion representation as the noisy motion representation based on the denoised motion representation and a motion representation obtained at a previous timestep; and
updating the timestep;
obtaining a final motion representation corresponding to a last timestep of the iterative refinement;
generating, based on the final motion representation, one or more motion clips defining avatar movements of the avatar; and
assembling the one or more motion clips into an animation controller represented by a motion graph specifying one or more transitions between animation states.

17. The non-transitory computer-readable medium of claim 16, wherein dynamically updating the keyframe mask comprises weighting keyframes based on magnitude of joint displacement or temporal motion energy.

18. The non-transitory computer-readable medium of claim 16, wherein the pre-trained diffusion model comprises a neural network trained to jointly process sparse keyframes and corresponding temporal indices to maintain timing consistency across motion sequences.

19. The non-transitory computer-readable medium of claim 16, wherein the noisy motion representation and the denoised motion representation each comprise skeletal pose data expressed as three-dimensional (3D) joint coordinates for a plurality of joints of the avatar.

20. The non-transitory computer-readable medium of claim 16, wherein the instructions cause the one or more processors to perform a further operation comprising:
generating, using at least one secondary pre-trained diffusion model, one or more additional motion clips that are temporally aligned with the one or more motion clips generated by the pre-trained diffusion model to form a combined set of motion clips.
